(19) United States
(12) Patent Application Publication
(10) Pub. No.: US 2017/0351979 A1
(43) Pub. Date: Dec. 7, 2017

(54) DEPLOYING DISPATCH FORM WITH IMPLIED WORKFLOWS TO MOBILE DEVICES

(71) Applicant: Formotus, Inc., Bellevue, WA (US)

(72) Inventors: Adriana Neagu, Mercer Island, WA (US); Glen Furnas, Bellevue, WA (US); Mihaela Armanasu, Redmond, WA (US)

(21) Appl. No.: 15/630,949

(22) Filed: Jun. 23, 2017

Related U.S. Application Data
(63) Continuation of application No. 13/586,743, filed on Aug. 15, 2012, now abandoned.

(51) Int. Cl. G06Q 10/06

(52) U.S. Cl. CPC G06Q 10/06; G06Q 10/06311; G06Q 10/063112

(57) ABSTRACT

A workflow system allows a user to define dispatch forms for use by workers working on jobs of various job types. A dispatch form is a combination of the form and a query for selecting jobs. A query specifies a criterion for matching jobs by specifying a field of the form and a corresponding data value. When a worker accesses a dispatch form via a mobile device, the query of the dispatch form is sent to a data store to access the data of jobs that are ready to be dispatched to that worker. The worker can then update the data of a job using the form of the dispatch form that has been deployed to the mobile device of that worker. As the data store is updated, queries for dispatch forms for other workers will indicate that the job is now ready to be dispatched to them.

This application is a continuation of U.S. patent application Ser. No. 13/586,741, filed Aug. 15, 2012, which is incorporated by reference herein in its entirety.

### BACKGROUND

Many organizations have developed extensive forms for desktop computers to support the functions of the organizations. For example, medical service providers have developed and use forms to support virtually every aspect of medical services, including forms to support patient registration, medical record keeping, insurance claim processing, inventory control, appointment scheduling, and so on. Many products are available to facilitate the process of creating a form for a desktop computer. One popular forms development tool is InfoPath by Microsoft Corporation. An organization can use a forms development tool to generate forms that include various form controls, such as radio buttons, textboxes, and drop-down lists. The forms development tools may allow validation and allow an organization to provide business logic to be performed as a user interacts with the form. The forms development tools also allow rules and conditional formatting to guide the user in completing a form, including the ability to show or hide optional form sections. The forms development tools also allow forms to access various data sources, such as a database server or a web service provider.

After a form is created, forms development tools create a forms file that contains the information needed to run the form on virtually any desktop computer. For example, InfoPath creates a forms file in an XSN format that contains a manifest file, one or more view files, a template file, and one or more schema definition files. The manifest file contains a listing of all other files in the forms file and several other details including metadata, information on toolbars and menus associated with each view, information on external data sources, and error messages. A view file is an eXtensible Stylesheet Language Transformation (“XSLT”) transform that presents an editable view of a portion of data in an eXtensible Markup Language (“XML”) format. Each view file accepts XML data as input and produces an output format similar to a HyperText Markup Language (“HTML”) format. The schema file is an XML Schema Definition (“XSD”) file that defines the XML format of the XML data that can be processed by the view file. If the XML data does not conform to the schema, the view file may not process the form. The template file contains initial data for the form in XML format. A forms file may also include a script file that contains scripts specified by the form developer for performing business logic and other validation. The manifest also may list additional resource files such as images, xml data files, etc.

A form may be published to a share server so that users may access the form to view and update data associated with that form. SharePoint is a web application provided by Microsoft Corporation that provides functions of a share server. A share server maintains a list of published forms and may store the data associated with a form. A share server may maintain a database table for each published form with each entry of the table containing instance data of the form. For example, a construction company may publish a project form for tracking data relating to the projects or jobs that are in progress. The project form may specify the work that needs to be performed (e.g., plumbing and drywalling) to complete the project. The database table for the project form may have a separate entry for each project. A user uses the project form to view and update the data for the projects.

Many organizations use workflows to help track tasks that need to be performed for a project. For example, a construction company may define a workflow that specifies the tasks that need to be performed to remodel a kitchen. The remodeling tasks may include removing cabinets and appliances, rerouting the plumbing, repairing the drywall, installing new cabinets and appliances, painting, and so on. A workflow may describe the order of the tasks as well as identify the workers or categories of workers that are to perform each task. Tools that provide workflows may be client/server based. A server maintains the information for workflow of projects, and workers using their computers as clients access the server to perform the tasks of a project in an order specified by the associated workflow.

The workforces of organizations are increasingly using a variety of devices including mobile devices (e.g., smart phones, PDAs, tablets, and notebooks) to collect and access the data of the organization. For example, workers of a construction company may use their cell phones to view various work orders and update the work orders' status. It can, however, be costly and time-consuming to develop and deploy application programs to mobile devices to track projects, especially when the projects have associated workflows.

### BRIEF DESCRIPTION OF THE DRAWINGS

FIG. 1 is a block diagram that illustrates an example of processing to create, deploy, and use a dispatch form in some embodiments.

FIGS. 2A-2E illustrate example uses of dispatch forms at a mobile device.

FIG. 3 is a diagram illustrating possible workflows for an example job type.

FIG. 4 is a block diagram that illustrates the creation, deployment, and use of dispatch forms of the workflow system in some embodiments.

FIG. 5 is a flow diagram that illustrates the overall processing of creating and deploying a dispatch form.

FIG. 6 is a flow diagram that illustrates the processing of a create dispatch form component of the mobile forms server of the workflow system in some embodiments.

FIG. 7 is a flow diagram that illustrates the processing of the deploy dispatch form component of the mobile forms server of the workflow system in some embodiments.

FIG. 8 is a flow diagram that illustrates the processing of the display dispatch forms component of the workflow system that executes on a mobile device in some embodiments.

FIG. 9 is a flow diagram that illustrates the processing of a display job component of the workflow system that executes on a mobile device in some embodiments.

### DETAILED DESCRIPTION

A method and system for deploying to mobile devices dispatch forms with implied workflows is provided. In some embodiments, a workflow system allows a user to define dispatch forms for use by workers working on jobs of various job types. For example, a construction company may define a job type for remodeling a kitchen and another job type for installing new roofing. When a new job type is defined, a user may create a form using a forms development tool (e.g., InfoPath). The user then publishes the form to a share server (e.g., SharePoint). The workflow system provides a mobile forms server through which a user creates dispatch forms for that job type and then deploys the dispatch form to the mobile devices of the various workers. A dispatch form is a combination of the form and a query for selecting jobs. For example, in the case of remodeling jobs, one dispatch form that includes a query for selecting jobs that are ready to be dispatched to a plumber may be created for plumbers, and another dispatch form that includes a query for selecting jobs that are ready to be dispatched to a drywaller may be created for drywallers. A query specifies a criterion for matching jobs by specifying none, one, or multiple fields of the form and corresponding data values or ranges. For example, a query of a dispatch form for a plumber may specify a criterion that cabinet removal is complete and plumbing is not complete, and a query of a dispatch form for a drywaller may specify a criterion that plumbing is complete and drywalling is scheduled but not complete. The workflow system then allows the dispatch form to be deployed to the mobile devices of the workers based on their roles (e.g., plumber or drywaller). For example, the dispatch form for a plumber is deployed to the mobile devices of plumbers, and the dispatch form for a drywaller is deployed to the mobile devices of drywallers. When a worker accesses a dispatch form via a mobile device, the query of the dispatch form is sent to a data store, which may be part of the share server, to access the data of jobs that are ready to be dispatched to that worker. The worker can then view and update the data of a job that is ready to be dispatched to that worker using the form of the dispatch form that has been deployed to the mobile device of that worker. As the workers complete their work on a job, they update the data of the job at the data store so that queries for dispatch forms for other workers will indicate that the job is now ready to be dispatched to them. Because the queries define the jobs that are ready to be dispatched to the workers with various roles, the queries for a job type define one or more implied workflows for jobs of the job type.

In some embodiments, the workflow system includes a server-side component and a client-side component. The server-side component executes on a mobile forms server and controls the defining and deployment of dispatch forms. The mobile forms server receives from a user a selection of a form for accessing jobs of a job type. The form may be a form published to a forms server, and the data of the jobs (e.g., defined by the fields of the form) may be stored at a data store that is a separate server (e.g., an internal server of an organization). The mobile forms server allows the user to create a dispatch form for each role of a worker to whom the jobs of the job type are to be dispatched. Additionally, a manager may be able to view on their mobile device all jobs, or all open jobs. To create a dispatch form, the mobile forms server receives from the user a query for the role to be combined with the selected form as part of the dispatch form. The query specifies a criterion for jobs that are accessible (e.g., ready to be dispatched) to the workers having that role. For example, the query may have a format that is similar to a “where” clause of an SQL query. The mobile forms server then associates the received query with the selected form to generate a dispatch form for the workers having that role. The dispatch form is a combination of the selected form and the received query. The mobile forms server then deploys the dispatch form for that role to the mobile devices of workers with that role. Because role-specific dispatch forms are deployed to the mobile devices of workers, each worker will have access only to jobs that match the query of the dispatch form for that worker's role. Each worker may have none, one, or multiple dispatch forms deployed to their mobile device.

In some embodiments, the client-side component of the workflow system executes on the mobile devices and controls the presenting of jobs to workers via their mobile devices. After a mobile device has received a dispatch form, the client-side component submits the query of the dispatch form to a data store that stores the data for the jobs. The dispatch form may include an identifier or address of the data store, which may be located at the same server as the share server to which the form was published or a different server. The client-side component then receives from the data store an indication of the jobs that match the submitted query. For example, the mobile device of a plumber receives an indication of the jobs that are accessible to the plumber. After receiving the indication of the jobs that match the submitted query, the client-side component may display the jobs to the worker to allow the worker to select a job that the worker will work on next. The client-side component submits to the data store a request to dispatch the selected job to the mobile device of the worker. The data store may check the job out to the mobile device, effectively preventing the job from being dispatched to another mobile device. After the mobile device receives the data of the selected job, the client-side component stores the data locally and presents the data of that job to the worker using the form of the dispatch form. The data defines the task that the worker is to perform. When the worker completes the task, the worker, using the mobile device, updates the data of the job to indicate that the task is complete. The client-side component then submits to the data store a request to store the updated data of the job and check the job in as appropriate so that the job can be dispatched to the mobile devices of other workers according to the implied workflow of the job.

In some embodiments, the client-side component may be adapted to access data of a job, which is stored individually in a file via a dispatch form for the job type of that job. For example, a job may be checked out by a worker from a data store and stored in a file (e.g., an XML document) of the mobile device of the worker. The worker may send an electronic mail message to a co-worker that includes the file with the data of the job. The co-worker, who may have the same role as the worker, may use the dispatch form for the job type deployed to their mobile device to display and modify the data of the job. The client-side component may allow the co-worker to check the job into the data store or send the updated file back to the worker for further processing. The client-side component may automatically identify the dispatch form deployed to the mobile device of the co-worker to use in displaying the data of the job (e.g., based on job type associated with the data stored in the file). Alternatively, the client-side component may allow the co-worker to select the appropriate dispatch form and then select file with the data of the job. The client-side component may be adapted to access the data of a job that is stored in a file locally at the mobile device or remotely at servers or other data sources.

In some embodiments, the mobile devices of organization may be licensed to interact with a mobile forms server using a progressive pricing scheme. The progressive pricing scheme avoids an anomaly of conventional pricing schemes in which the cost of more licenses is less than the cost of fewer licenses. Such conventional pricing schemes set prices based on ranges of total number of licenses of units. The following table illustrates an example of a conventional pricing scheme,

| Total Number of Licenses | Cost per License |
|---|---|
| 1-10 | $45 |
| 11-20 | $40 |
| 21-50 | $42.50 |

As illustrated by the first license range (or unit range) when the total number of licenses is 10 or less, then the cost for 1 license is $45, 2 licenses is $90, and 10 licenses is $450. As illustrated by the second license range when the total number of licenses is from 11 to 20, then the cost for 1 license is $40, 2 licenses is $80, . . . , 10 licenses is $400, 11 licenses is $440, . . . , and 20 licenses is $800. The anomaly occurs, for example, when the total number of licenses is 10 or 11. When the total number of licenses is 10 the cost is $450 and when the total number of licenses is 11 the cost is $440. Under this conventional pricing scheme, the cost of 10 licenses is more than the cost of 11 licenses. A progressive pricing scheme avoids this anomaly by ensuring that cost of fewer licenses is less than the cost of more licenses. With the progressive pricing scheme, the cost per license only applies to the licenses in the license range and not to all the licenses. If the pricing is as illustrated in the table above, the cost for first 10 licenses is $450 regardless of the total number of licenses; the cost for the next 10 licenses is $400; and so on. Thus, with the progressive pricing scheme the cost of 10 licenses is $450 and the cost of 11 licenses is $490. The licenses may be charged on a per-form, per-mobile device, per-user, and on the per-unit basis.

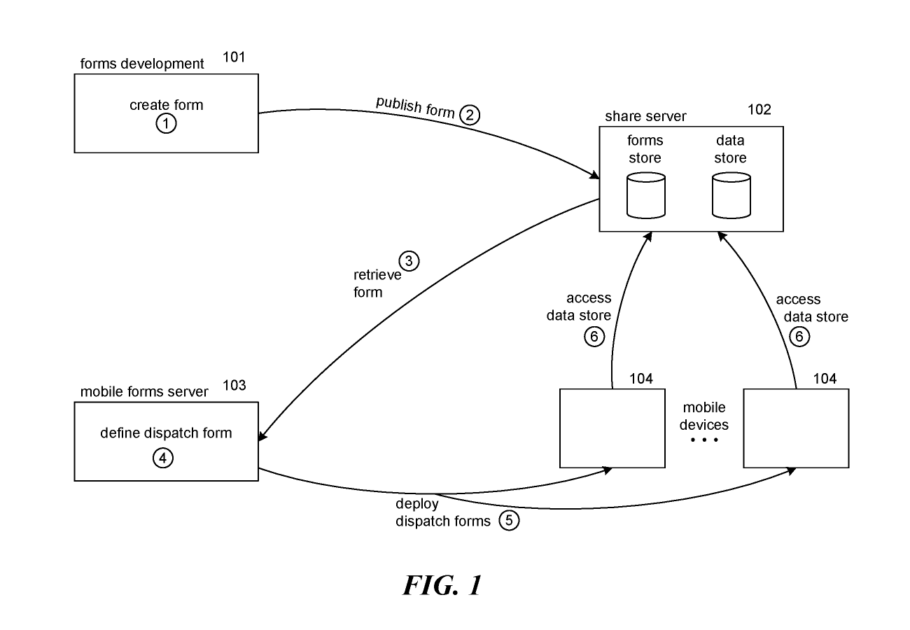

FIG. 1 is a block diagram that illustrates an example of processing to create, deploy, and use a dispatch form in some embodiments. In this example, users interact with a forms development tool 101, a share server 102, a mobile forms server 103, and mobile devices 104. A user initially creates (1) a form using the forms development tool (e.g., InfoPath). A form may include various pages that provide access to different subsets of the fields of the form. For example, a form may include a page with fields relating to a plumbing task and may also include a page with fields relating to a drywalling task. After creating the form, the user publishes (2) the form to the share server (e.g., SharePoint) to make it available to various users. The share server stores the published form and maintains a data store for storing the data for instances of the form. The share server may allow users to access the published form to view and update the corresponding data using desktop computers. The share server may be an internal server of an organization that is accessible via a local area network (“LAN”), a web portal, or other access mechanism. When a user wants to create a dispatch form, the user accesses a create dispatch form component of the mobile forms server. The create dispatch form component retrieves (3) a selected form from the share server. The user then interacts with the create dispatch form component to define (4) the dispatch form for each role (e.g., plumbers or drywallers) to be a combination of the retrieved form and a user-specified query for that role. The mobile forms server may convert the form into a format that is appropriate for a mobile device and deploy (5) the dispatch form to mobile devices as described in U.S. patent application Ser. No.12/040,505, entitled “Forms Conversion and Deployment System for Mobile Device” and filed on Feb. 28, 2008, which is hereby incorporated by reference. A user of a mobile device interacts with the dispatch form to access (6) data at the share server. The data of the share server may also be accessed directly through the published forms. Thus, the data of a form can be updated either using a dispatch form via a mobile device or using a published form using a conventional access mechanism. The mobile forms server may also include a pricing component that implements a progressive pricing scheme. The pricing component may track usage by mobile devices of organization and direct that the organization be billing in accordance with the usage. Alternatively, the organization may be billed for a fixed number of mobile devices even though fewer than that number of the mobile devices may actually use the client-side component, form, or other licensing unit during a billing period.

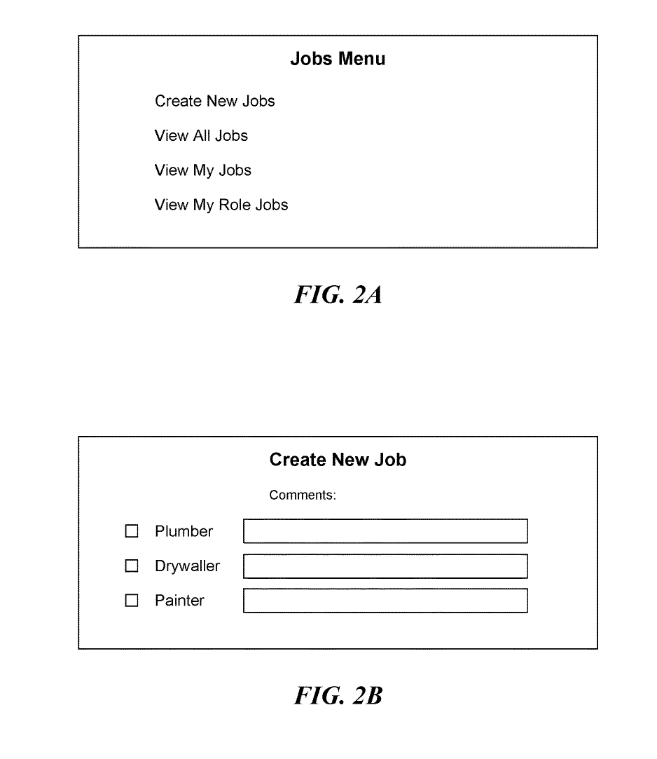

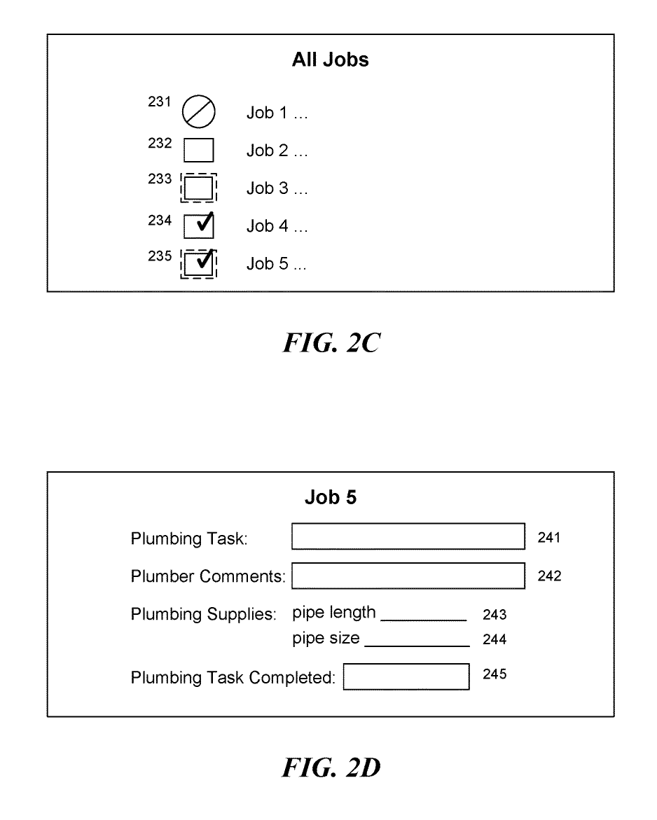

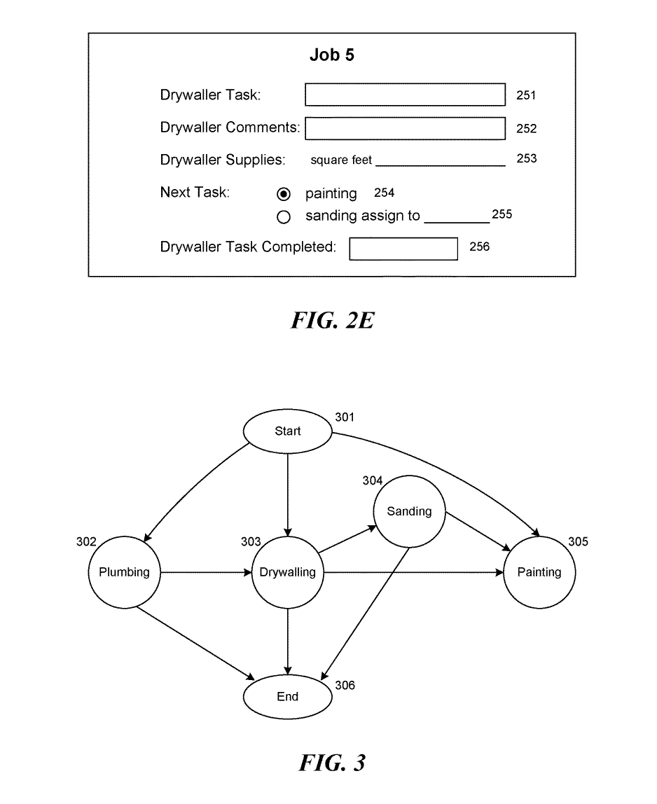

FIGS. 2A-2E illustrate example uses of dispatch forms at a mobile device. FIG. 2A illustrates a display of available options for processing a dispatch form for a certain job type by the client-side component of the workflow system. The options are create new jobs, view all jobs, view my jobs, and view my role jobs. FIG. 2B illustrates a display for creating a new job. In this example, the job type allows jobs to be created that can include any combination of plumbing, drywalling, and painting tasks. The user creating a new job selects the task and adds comments describing the tasks to be performed. When dispatch forms for a job type are created, a dispatch form may be created for the role of dispatcher. Such a dispatcher, rather than the workers responsible for performing the various tasks, may create new jobs and indicate that the jobs are ready to be dispatched to the workers in accordance with the implied workflows of the new jobs. FIG. 2C illustrates a display for listing jobs that are accessible to the worker of the mobile device. In this example, Jobs 1-5 are jobs that are ready to be dispatched or currently dispatched to workers with the same role as the worker of the mobile device. The universal no symbol 231 by Job 1 indicates that the job is currently dispatched to and grabbed by another worker and is thus not available to be grabbed by this worker. A blank checkbox 232 or 233 by a job indicates that the job is available to be checked out to the worker of the mobile device. A checkbox 234 or 235 with a check indicates that the job is currently checked out to this worker of the mobile device. A checkbox 233 or 235 that is further highlighted with a dashed surrounding box indicates that the job is specifically assigned to the worker of the mobile device. The checkboxes, universal no symbol, and dashed surrounding box are just examples of how the information about the status of jobs can be presented to the worker. The different statuses can be highlighted in various ways such as using colors, shapes, text, and so on. FIG. 2D illustrates a display of a dispatch form for Job 5 at the mobile device of a plumber. The dispatch form includes fields 241-245. The plumbing task field 241 includes a description of the task that the plumber is to perform as indicated when the job was initially created. The plumber comments field 242 allows the plumber to add comments to the job. The pipe length field 243 and pipe size field 244 allow the plumber to enter information describing the supplies that were actually used in completing the job. The plumbing task completed field 245 allows the plumber to designate when the task is completed. FIG. 2E illustrates a display of a dispatch form for Job 5 at the mobile device of a drywaller. The dispatch form includes fields 251-256. The drywaller task field 251 includes a description of the task that the drywaller is to perform as indicated when the job was initially created. The drywaller comments field 252 allows the drywaller to add comments to the job. The square feet field 253 allows the drywaller to enter information describing the supplies that were actually used in completing the job. The painting and sanding radio buttons 254 allow the drywaller to designate the next task that is to be performed. The assign to field 255 allows the drywaller to assign the next task to a specific worker who is a sander, rather than to any worker with the role of sander. The drywaller task completed field 256 allows the drywaller to designate when the task is completed.

FIG. 3 is a diagram illustrating possible workflows for an example job type. Each directed path from the start task 301 to the end task 306 represents a possible workflow. In this example, the job type allows jobs to be created that include various combinations of plumbing, drywalling, sanding, and painting tasks but in an implied order as indicated by the directed links. For example, the directed link from the plumbing task 302 to the drywalling task 303 indicates that the plumbing task 302, if selected to be part of a job, is performed before any drywalling task 303. To create the dispatch forms for the roles of these tasks, a user creates a form that includes a page for each of the roles (e.g., plumber, drywaller, sander, and painter) of workers to whom a job might be dispatched. The user then publishes that form to the share server which can be on premise or in the cloud. The user then interacts with a mobile forms server to specify a query for each role to create a dispatch form for each role and to deploy the dispatch form for a role to the mobile devices of workers with that role. When a job is created for this example job type, the workflow for that job may be specified using the display of FIG. 2B. The user can select, for example, the plumbing task and the painting task. In such a case, the workflow for the job would be the start task 301, the plumbing task 302, the painting task 305, and the end task 306, in that order. As another example, the user can select the drywalling task 303 and the painting task 305. In such a case, the workflow would be the start task 301, the drywalling task 303, optionally the sanding task 304, the painting task 305, and the end task 306. The sanding task 304 is optional in the sense that the drywaller at completion of the drywalling task can select the next task to be the sanding task 304 or the painting task 305 as illustrated by FIG. 2E.

Tables 1-5 illustrate data of a job type and queries for implementing possible workflows of FIG. 3. Table 1 provides a description of some of the fields of the pages of the form of the dispatch forms. Tables 2-5 provide queries for the various roles implementing an implied workflow. For example, if a job is created that specifies only the plumbing task and the painting task, then the Psched and Fsched fields (“P” stands for “plumber,” “D” stands for drywaller, “S” stands for “sander,” and “F” stands for “painter”) are set to true and Dsched is set to false.

TABLE 1

| Field | Descriptions |
|---|---|
| Field | Description |
| Status | (not started, started, completed) |
| Psched | plumbing task is scheduled for the job |
| Pcomp | plumbing task is completed |
| Dsched | drywalling task is scheduled for the job |
| Dcomp | drywalling task is completed |
| Dnext | Sanding task or painting task is next after drywalling |
| Sassign | Sanding task is assigned to specific sander |
| Fsched | Painting task is scheduled for the job |
| Fcomp | Painting task is complete |

TABLE 2
Plumber Query

| Description | Query |
|---|---|
| | Status == started AND |
| P scheduled and | (Psched == true AND Pcomp == false) |
| not complete | |

TABLE 3
Drywaller Query

| Description | Query |
|---|---|
| | Status == started AND |
| P complete or not | ((Psched == true AND Pcomp == true) |
| scheduled | OR Psched == false) AND |
| D scheduled and | (Dsched == true AND Dcomp == false) |
| not complete | |

TABLE 4
Sander Query

| Description | Query |
|---|---|
| | Status == started AND |
| S assigned and S | (Dnext == S AND Scomp == false) |
| not complete | |

TABLE 5
Painter Query

| Description | Query |
|---|---|
| | Status == started AND |
| P complete or not | ((Psched == true AND Pcomp == true) OR |
| scheduled | Psched == false) AND |
| D complete and (S is | (((Dsched == true AND Dcomp == true) AND |
| next and complete) | ((Dnext == S AND Scomp == true) OR |
| or (F is next and not | (Dnext == F AND Fcomp == false)) |
| complete) or | OR |
| D not scheduled and | (Dsched == false AND (Fsched == true |
| F scheduled and not | AND Fcomp == false))) |
| complete | |

An example will help illustrate how the queries specify an implied workflow. If a job is created that specifies only the plumbing task and the painting task, then the Psched and Fsched fields are set to true and Dsched is set to false. When the dispatch forms are deployed, the plumbers receive a dispatch form with the plumber query and the painters receive a dispatch form with the painter query. When a plumber requests to view the accessible jobs for that dispatch form, the query selects those jobs that have been started and for which the plumbing task is scheduled but not completed. The queries for the drywaller and painter would not select any of the same jobs because their queries only select jobs with a scheduled plumbing task that is complete. The painter query is more complex than the plumber and drywaller queries because it needs to ensure that if the plumbing task and drywalling task are scheduled and optionally the sanding task is selected next by a drywaller, they each need to be completed before a job is accessible to a painter.

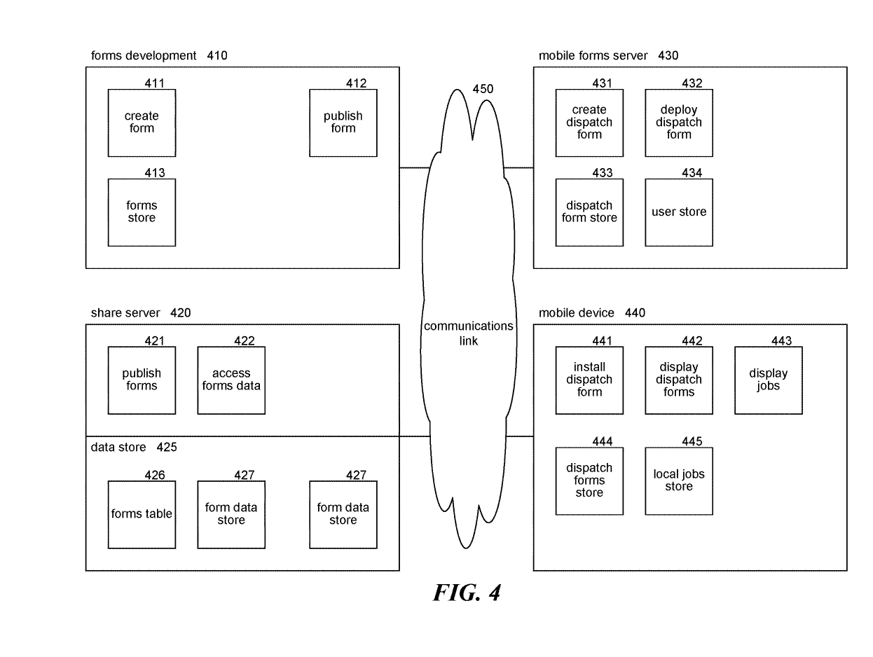

FIG. 4 is a block diagram that illustrates the creation, deployment, and use of dispatch forms of the workflow system in some embodiments. The forms development tool 410, the share server 420, the mobile forms server 430, and mobile devices 440 are connected via a communications link 450. The forms development tool 410, which may execute on a desktop computer, includes a create form component 411, a publish form component 412, and a forms store 413. The forms store 413 may alternatively be stored in the share server 420. The create form component and the publish form component may be provided by a conventional forms development tool (e.g., InfoPath) to create and publish forms. The forms that are created may be stored in the forms store 413. The share server 420 includes a publish forms component 421 and an access forms data component 422. The components of the share server may be provided by a conventional share server (e.g., SharePoint) to receive publications of forms and allow users to access data of the forms. The share server 420 also includes a data store 425, which includes a forms table 426 and form data stores 427 for storing the published forms and instance data for the published forms. For example, each published form may have a separate form data store with an entry for each instance of the data of the form. The share server may also provide an interface for accessing the data store by various remote systems.

The mobile forms server 430 includes a create dispatch form component 431, a deploy dispatch form component 432, a server-side dispatch forms store 433, and a user store 434. The create dispatch form component allows a user to select a published form from the share server to use as the basis of the dispatch forms for a job type. The create dispatch form component allows the user to define a query that is specific to a role and combine that query with a page or view of the published form to generate the dispatch form. The deploy dispatch form component coordinates the deployment of the dispatch forms to the mobile devices based on the roles of the dispatch form. The server-side dispatch forms store stores the information describing each dispatch form. The user store contains information describing the various users, their mobile devices, their roles, and so forth. Each mobile device 440 includes an install dispatch form component 441, a display dispatch forms component 442, and a display jobs component 443. The mobile devices also include a client-side dispatch forms store 444 and a local jobs store 445. The install dispatch form component receives dispatch forms from the mobile forms server that are to be installed on the mobile device and stores the dispatch form information in the dispatch forms store. The display dispatch forms component displays the dispatch forms that have been deployed to the mobile device so that the worker can select a dispatch form. The display jobs component displays the jobs that are accessible to the mobile device for a selected dispatch form. The display dispatch forms component and the display jobs component interact with the data store of the share server to select and update the jobs that are accessible to the mobile device. The local jobs store stores data for jobs that have been checked out to (or dispatched to) the mobile device.

The computer systems on which the workflow system is implemented may include a central processing unit, memory, input devices (e.g., keyboard and pointing devices), output devices (e.g., display devices), and storage devices (e.g., disk drives). The memory and storage devices are computer-readable storage media that may be encoded with computer-executable instructions that implement the workflow system, which means a computer-readable storage medium that contains the instructions. The computer-readable storage media may be characterized as tangible and non-transitory. In addition, the instructions, data structures, and message structures may be transmitted via a data transmission medium, such as a signal on a communication link. Various communication links may be used, such as the Internet, a local area network, a wide area network, a point-to-point dial-up connection, a cell phone network, and so on.

Embodiments of the workflow system may be implemented in various operating environments that include personal computers, server computers, hand-held or laptop devices, multiprocessor systems, microprocessor-based systems, programmable consumer electronics, digital cameras, network PCs, minicomputers, mainframe computers, cell phones, personal digital assistants, smart phones, personal computers, programmable consumer electronics, distributed computing environments that include any of the above systems or devices, and so on.

The workflow system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

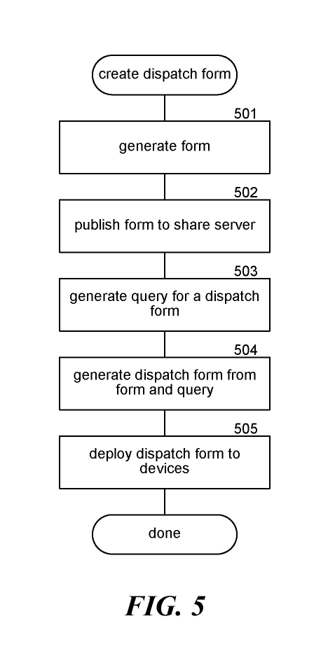

FIG. 5 is a flow diagram that illustrates the overall process of creating and deploying a dispatch form. In block 501, a user initially starts out by creating a form for one or more job types using a forms development tool. The form may include a separate page (also referred to as a view) for each task that may be scheduled for jobs of that job type. For example, for a construction job type, a separate page may be defined for a plumber, a drywaller, and a painter. In block 502, the user publishes the generated form to a share server. A published form is available through the share server for users to update the data of the forms in accordance with capabilities provided by the share server. Although a share server may provide capabilities for certain types of workflows, those workflows are conventional workflows that may not be specially adapted to handling the dispatch of jobs to the mobile devices of workers. In block 503, the user interacts with the mobile forms server to generate a query for a dispatch form that includes a selected published form and the query. As part of creating the query, the user may need to direct the share server to make certain fields of a form available for use in a query—which is sometimes referred to a “promoting” a field. The share server may generate special data structures (e.g., indexes) for such promoted fields to facilitate searching for entries or records that match a query. In block 504, the user directs the mobile forms server to generate the dispatch form that is a combination of the form (and a specific page) and the query for a role (e.g., painter)—although the specifying of the role may be done indirectly by deploying the form to mobile devices of workers with that role. In block 505, the user directs the mobile forms server to deploy the generated dispatch form to the workers with the specified role. The processing of blocks 503-504 may be repeated to create and deploy separate dispatch forms for each role.

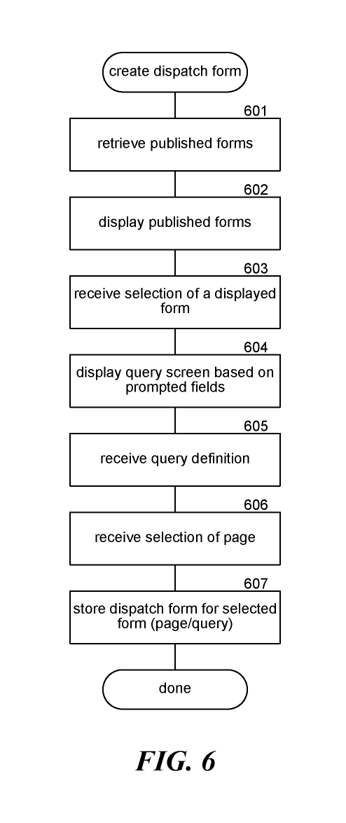

FIG. 6 is a flow diagram that illustrates the processing of a create dispatch form component of the mobile forms server of the workflow system in some embodiments. The component allows a user to create a dispatch form based on an existing form for a job type and a query that is specific to the role of the workers who are to perform various tasks of jobs of that job type. In block 601, the component retrieves a list of the published forms from the share server. In block 602, the component displays an indication of the published forms. In block 603, the component receives from the user a selection of a published form. In block 604, the component displays a query screen based on promoted fields of the selected form. The query screen allows the user to specify the promoted fields and their values for jobs that match the query. The query may include regular expressions and Boolean operators. The component may allow the user to promote fields at the share server as needed. In block 605, the component receives the query definition based on the promoted fields as well as specific variables of the user store or other administrative data on the mobile forms server (e.g., user name). In block 606, the component receives from the user a selection of a page of the selected form. In block 607, the component stores in the server-side dispatch forms store a dispatch form as a combination of the page of the selected form and the defined query. The dispatch form is then ready to be dispatched to the mobile devices based on the roles of the workers.

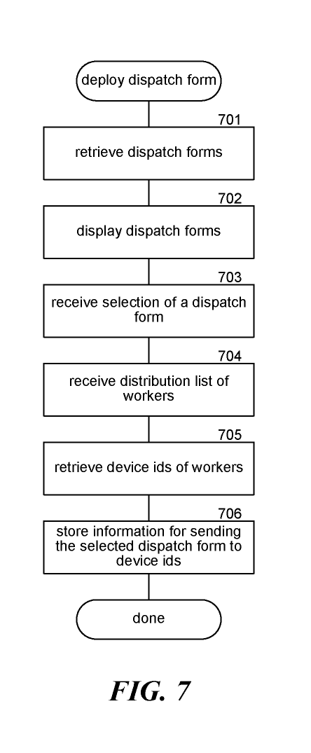

FIG. 7 is a flow diagram that illustrates the processing of the deploy dispatch form component of the mobile forms server of the workflow system in some embodiments. The component allows a user to select a dispatch form and indicate the mobile users to which the selected dispatch form is to be deployed. In block 701, the component retrieves an indication of the dispatch forms from the server-side dispatch forms store of the mobile forms server. In block 702, component displays an indication of the dispatch forms. In block 703, the component receives a selection of a dispatch form from the user. In block 704, the component receives a distribution list of workers, which may be specified as a role, multiple roles, an identifier of one or more workers, and so on, for deployment of the dispatch form to the mobile devices of those workers. In block 705, the component retrieves the mobile device identifiers of the workers of the distribution list from the user store. In block 706, the component stores information so that the selected dispatch form is sent to the mobile devices when the workers log in via their mobile devices. The component then completes.

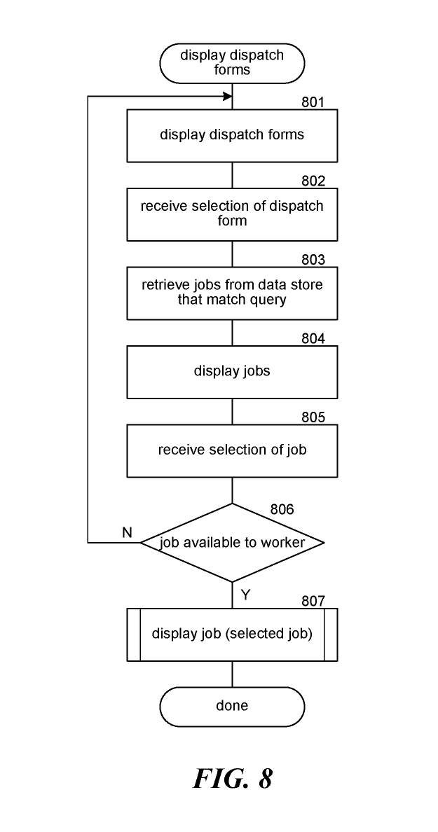

FIG. 8 is a flow diagram that illustrates the processing of the display dispatch forms component of the workflow system that executes on a mobile device in some embodiments. The component executes on a mobile device to allow workers to access jobs and update the jobs that have been dispatched to the workers. In block 801, the component displays an indication of the dispatch forms that have been installed on the mobile device and stored in the client-side dispatch forms store. In block 802, the component receives from the worker a selection of a dispatch form. In block 803, the component retrieves an indication of the jobs from the data store of the share server that match the query of the selected dispatch form. In block 804, the component displays the indication of the jobs. In block 805, the component receives from the worker a selection of a displayed job. In decision block 806, if the selected job is available to the worker, then the component continues at block 807, else the component indicates that the job is not available and may loop to any of the blocks 801-805 to allow the worker to select another dispatch form or job. A job may not be available because it is currently checked out to another worker. In block 807, the component invokes a display jobs component to display the selected job to the worker and then loops to block 801 to allow the worker to select a new dispatch form.

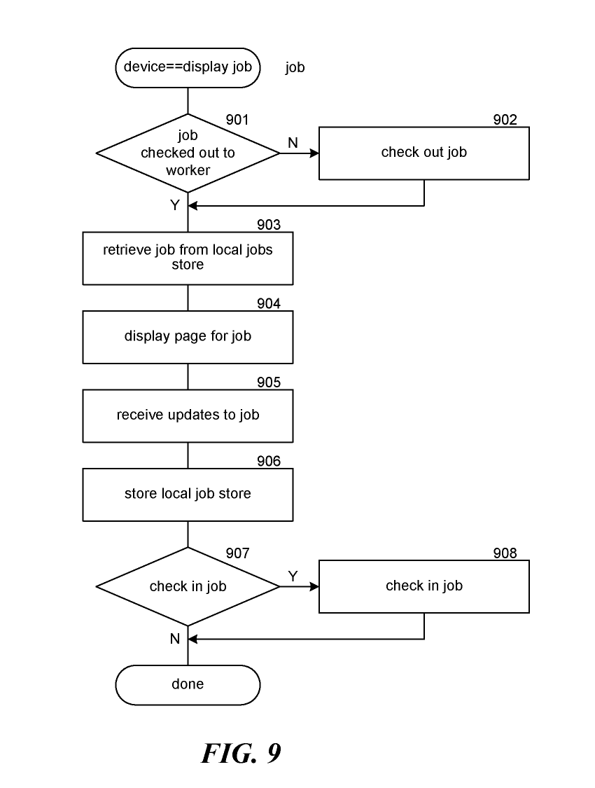

FIG. 9 is a flow diagram that illustrates the processing of a display job component of the workflow system that executes on a mobile device in some embodiments. The component is passed an indication of a selected job and allows the user to view and update data of the job. In decision block 901, if the selected job is currently checked out to the worker as indicated by the local jobs store of the mobile device, then the component continues at block 903, else the component continues at block 902. In block 902, the component interacts with the data store of the share server to check out the selected job and stores the job data in the local jobs store. In block 903, the component retrieves the data for the job from the local jobs store. In block 904, the component displays the page of the dispatch form for the selected job. In block 905, the component receives from the worker updates to the data of the selected job via the displayed page. In block 906, the component updates the data of the job in the local jobs store. In decision block 907, if the worker indicates the selected job is complete, then the component continues at block 908, else the component returns. In block 908, the component sends the updated data of the selected job to the data store of the share server to check in the job and then returns. The component may also send the updated data to the data store even if the selected job is not yet ready to be checked in (e.g., the worker has not yet completed the assigned task). If the mobile device is not currently connected to the share server, the form is saved in an outbox and then checked in at the next connectivity opportunity.

From the foregoing, it will be appreciated that specific embodiments of the invention have been described herein for purposes of illustration but that various modifications may be made without deviating from the scope of the invention. Although the workflow system has been described in the context of “mobile” devices such as smart phones and tablets, the dispatch forms can be also dispatched to devices that may be considered not to be “mobile,” such as desktop computers, or gaming/entertainment consoles. Accordingly, the invention is not limited except as by the appended claims.

I/We claim:

1. A method for deploying dispatch forms to mobile devices, the method comprising:
receiving from a user a selection of a form for accessing jobs of a job type, each job being an instance of the job type with data for that job, the data of the job being stored at a data store; and
for each of a plurality of roles,
receiving from the user a query for the role, the query for selecting jobs that are accessible to workers with that role, the query specifying a criterion for matching jobs;
associating the received query with the selected form to generate a dispatch form for the role; and
sending the dispatch form to mobile devices of workers with that role
such that when a dispatch form is deployed to a mobile device of a worker with a role of that dispatch form, only the jobs that match the query of the dispatch form are accessible by the worker via the mobile device.

2. The method of claim 1 wherein the queries for the roles specify an implied workflow for workers to process a job of the job type.

3. The method of claim 1 wherein the form includes multiple pages through which certain fields or sections of the jobs are accessible and each dispatch form for a role is associated with a specific page or section of the form.

4. The method of claim 1 wherein the data store includes a data structure for the job type with a record for each job.

5. The method of claim 1 wherein the job type has associated fields for the data of the jobs.

6. The method of claim 5 wherein the criterion specifies one or more fields and matching data values for the fields.

7. The method of claim 6 wherein the field of the criterion is a field of the job type designated as being promoted for use in a query.

8. The method of claim 1 wherein each dispatch form for a role has a query that is specific to the role.

9. A computer-readable storage medium storing computer-executable instructions for controlling a mobile device to present jobs to a worker, by a method comprising:
receiving a dispatch form for a job type, the dispatch form having a form and a query, the form for accessing jobs of the job type, the query specifying jobs that are accessible to the mobile device;
submitting the query to a data store;
receiving from the data store an indication of the jobs that match the submitted query; and
after receiving the indication of the jobs that match the submitted query,
submitting to the data store a request to access a matching job wherein the data store checks the matching job out to the mobile device;
receiving from the data store data of the matching job;
presenting the data of the matching job with the form of the dispatch form so that the data of the matching job can be updated; and
after presenting the data of the matching job, submitting to the data store a request to store the updated data of the matching job wherein the data store checks the matching job in from the mobile device.

10. The computer-readable storage medium of claim 9 wherein mobile devices of workers with different roles receive dispatch forms for the job type with different queries specifying the jobs that are accessible to workers with the different roles.

11. The computer-readable storage medium of claim 10 wherein the queries define an implied workflow for processing the job by workers with different roles.

12. The computer-readable storage medium of claim 9 including displaying a list of matching jobs and wherein the submitting of the request to access the matching job is in response to a selection of that matching job.

13. The computer-readable storage medium of claim 12 wherein the matching jobs are displayed with an indication of whether the jobs are checked out to the mobile device or another mobile device.

14. The computer-readable storage medium of claim 9 wherein the form has multiple pages and the data of the matching jobs is presented with a designated page.

15. The computer-readable storage medium of claim 14 wherein the designated page is based on a role of workers associated with the dispatch form.

16. A computer-readable storage medium storing computer-executable instructions for controlling a computer system to deploy dispatch forms to devices, the computer-executable instructions comprising:
a component that receives from a user a selection of a form for accessing jobs of a job type, each job being an instance of the job type with data for that job, the data of the job being stored at a data store; and
a component that, for each of a plurality of roles,
receives from the user a query for the role, the query for specifying a criterion for matching jobs;
associates the received query with the selected form to generate a dispatch form for the role; and
sends the generated dispatch form to a device of a worker with that role so that the worker can access matching jobs as specified by the query of the dispatch form via the received query and the selected form.

17. The computer-readable storage medium of claim 16 wherein the queries for the roles specify an implied workflow for workers to process a job of the job type.

18. The computer-readable storage medium of claim 16 wherein the form includes multiple pages through which data of the jobs is accessible and each dispatch form for a role is associated with a specific page of the form.

19. The computer-readable storage medium of claim 16 wherein the device of the worker retrieves from the data store data of a job that matches the query.

20. The computer-readable storage medium of claim 16 wherein each dispatch form includes a query that is specific to a role.

21. A method for billing for forms deployed to mobile devices by a mobile forms server, the method comprising:
for each of a first range and a second range of number of units, providing a cost per unit for that range wherein the first range and the second range do not overlap; and
billing an organization for a total number of units that is in the second range by charging the cost per unit of the first range for the number of units in the first range and the cost per unit of the second range for the number of units in excess of the number of units of the first range.
